(19) United States
(12) Patent Application Publication
(10) Pub. No.: US 2026/0176140 A1
(43) Pub. Date: Jun. 25, 2026

(54) SOLID ELECTROLYTE PRODUCTION PROCESS USING ALKALI METAL COMPOSITE

(71) Applicant: Solid Power Operating, Inc., Louisville, CO (US)

(72) Inventors: Victoria R. BACHTELL, Broomfield, CO (US); Jed LACOSTE, Denver, CO (US); Troy GOULD, Broomfield, CO (US); Joseph DUCHAJ, Denver, CO (US); Bradley J. ROSS, Norman, OK (US); Tyler BASSETT, Golden, CO (US)

(21) Appl. No.: 19/430,075

(22) Filed: Dec. 22, 2025

Related U.S. Application Data
(60) Provisional application No. 63/738,416, filed on Dec. 23, 2024.

(51) Int. Cl. C01B 17/22; H01M 6/18; H01M 10/0562

(52) U.S. Cl. CPC C01B 17/22; C01P 2004/62; C01P 2006/12; C01P 2006/40; H01M 6/18; H01M 10/0562; H01M 2300/0068

(57) ABSTRACT

Processes for producing sulfide-based solid electrolytes include preparing a slurry by mixing a solvent with an alkali metal sulfide having a surface area greater than 6 m²/g or an alkaline earth metal sulfide having a surface area greater than 6 m²/g and a secondary sulfide. The slurry is then dried to produce the sulfide-based solid electrolyte.

### CROSS-REFERENCE TO RELATED APPLICATION

This application is related to and claims priority under 35 U.S.C. § 119(e) from U.S. patent application Ser. No. 63/738,416 filed Dec. 23, 2024, titled “Solid Electrolyte Production Process Using Alkali Metal Composite,” the entire contents of which is incorporated herein by reference for all purposes.

### TECHNICAL FIELD

Various embodiments described herein relate to the field of primary and secondary electrochemical cells, solid electrolytes, and electrolyte materials, and the corresponding methods of making and using the same.

### BACKGROUND

Solid electrolyte materials can be made by mixing precursor materials together and applying heat. A common problem that arises is that the selected mixing process used does not produce a homogeneous composite. Due to inadequate mixing, the produced composite when heated results in an electrolyte material with a large number of impurities. One way to improve mixing is to use one or more solvents during the mixing process. However, when using solvents the next concern is the solids loading of the slurries. In a production setting it is advantageous to create a slurry with the highest solids loading possible while still being able to produce a pure electrolyte material.

One challenge when attempting to increase the solids loading is that the rheology or viscosity of the slurry increases as you add more solids. If the rheology of the slurry is too high, then overheating of the slurry may occur, which may promote unwanted side reactions resulting in impurities. One way to achieve higher solids loading is to use a dispersing medium or surfactant. This surfactant is added during the milling process which can help lower the viscosity of the slurry. The major downside of using a surfactant is that it may react with the solid electrolyte material during the drying process or the crystallization process.

It is with these observations in mind, among others, that aspects of the present disclosure were conceived.

### SUMMARY

Provided herein are processes for producing sulfide-based solid electrolytes. The process generally includes preparing a slurry by mixing a solvent and electrolyte precursors, the electrolyte precursors comprising: an alkali metal sulfide having a surface area greater than 6 m²/g or an alkaline earth metal sulfide having a surface area greater than 6 m²/g; and a secondary sulfide; and drying the slurry to produce a sulfide-based solid electrolyte. In some embodiments, the electrolyte precursors further comprise LiX, wherein X is F, Cl, Br, or I. In some embodiments, the alkali metal sulfide comprises A₂S, wherein A is Li, Na, or any combination thereof. In some embodiments, the secondary sulfide comprises P₂S₅, SiS₂, Sb₂S₃, GeS₂, SnS₂, or any combination thereof. In some embodiments, the alkali metal sulfide has a D50 particle size of 100 nm or larger. In some embodiments, the sulfide-based solid electrolyte comprises an Argyrodite phase and the alkali metal sulfide comprises Li₂S. In some embodiments, the solvent comprises an ether, ester, nitrile, or hydrocarbon solvent. In some embodiments, the solvent comprises acetonitrile, propionitrile, butyronitrile, isobutyronitrile, benzonitrile, or any combination thereof. In some embodiments, the solvent comprises an alkane, a blend of alkanes, xylene, toluene, benzene, decalin, 1,2,3,4-tetrahydronaphthalene, or any combination thereof. In some embodiments, the drying comprises spray-drying at a temperature from about 20° C. to about 250° C. In some embodiments, the process further includes heating the sulfide-based solid electrolyte to a temperature from about 150° C. to about 600° C.

Further provided herein are processes for producing a sulfide-based solid electrolyte that include preparing a slurry by mixing a solvent and electrolyte precursors, the electrolyte precursors comprising: an alkali metal sulfide composite, and a secondary sulfide; and drying the slurry to produce the sulfide-based solid electrolyte, wherein the alkali metal sulfide composite comprises a first alkali metal sulfide and a second alkali metal sulfide, wherein the second alkali metal sulfide has a D50 particle size that is at least two times greater than the D50 particle size of the first alkali metal sulfide. In some embodiments, the first alkali metal sulfide comprises lithium. In some embodiments, the second alkali metal sulfide comprises lithium. In some embodiments, the second alkali metal sulfide has a D50 particle size that is at least 10 times greater than the D50 particle size of the first alkali metal sulfide. In some embodiments, the alkali metal sulfide composite further comprises a third alkali metal sulfide having a D50 particle size that is at least two times greater than the D50 particle size of the second alkali metal sulfide. In some embodiments, the electrolyte precursors further comprise LiX, wherein X is F, Cl, Br, or I. In some embodiments, the alkali metal sulfide comprises A₂S where A is one or more of Li and Na. In some embodiments, the secondary sulfide comprises one or more of P₂S₅, SiS₂, Sb₂S₃, GeS₂, SnS₂. In some embodiments, the first alkali metal sulfide has a D50 particle size of 100 nm or larger. In some embodiments, the sulfide-based solid electrolyte comprises an Argyrodite phase, and the alkali metal sulfide comprises Li₂S. In some embodiments, the solvent comprises an ether, ester, nitrile, or hydrocarbon. In some embodiments, the solvent comprises acetonitrile, propionitrile, butyronitrile, isobutyronitrile, benzonitrile, and combinations thereof. In some embodiments, the solvent comprises an alkane or blend of alkanes, xylene, toluene, benzene, decalin, 1,2,3,4-tetrahydronaphthalene, or any combination thereof. In some embodiments, the drying comprises spray-drying at a temperature ranging from about 20° C. to about 250° C. In some embodiments, the process further comprises heating the sulfide-based solid electrolyte to a temperature from about 150° C. to about 600° C.

### BRIEF DESCRIPTION OF DRAWINGS

The present disclosure may be understood by reference to the following detailed description taken in conjunction with the drawings briefly described below.

FIG. 1A is an illustration of a synthesis method according to one embodiment of the present disclosure;

FIG. 1B is an illustration of a synthesis method according to another embodiment of the present disclosure.

### SUMMARY

Before aspects of the present invention are disclosed and described, it is to be understood that the various aspects of the invention are not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.” The endpoint may also be based on the variability allowed by an appropriate regulatory body, such as the FDA, USP, etc.

In this disclosure, the terms “including,” “containing,” and/or “having” are understood to mean comprising, and are open ended terms.

### DETAILED DESCRIPTION

Provided herein are processes for producing a sulfide-based solid electrolyte. The process generally includes making a precursor slurry. The precursor slurry comprises a solvent and solid electrolyte precursors comprising: an alkali metal sulfide or an alkaline earth metal sulfide; a secondary sulfide; optionally, an alkali halide or an alkali pseudohalide; and, optionally, a secondary halide, such as an alkaline earth metal halide. The alkali metal sulfide may include lithium sulfide or sodium sulfide, and may have a surface area greater than 6 m²/g. The inventors surprisingly found that by using an alkali metal sulfide having a large surface area (i.e., greater than 6 m²/g), the viscosity of the precursor slurry during the milling process may be dramatically reduced. This reduction in the viscosity of the precursor slurry has a beneficial impact on solids loading on the slurry, as well as the morphology and particle size of the final electrolyte material. Making the precursor slurry includes combining mixing the components of the slurry described above. The precursor slurry may then be milled to reduce the particle size of the precursors. In still further embodiments, the process further comprises removing the solvent from the milled mixture under vacuum or atmospheric pressure prior to the heating step. In some embodiments, the process further comprises heating the sulfide-based solid electrolyte after removing the solvent from the milled mixture. In some aspects, the sulfide-based solid electrolyte is heated to a temperature from about 150° C. to about 600° C.

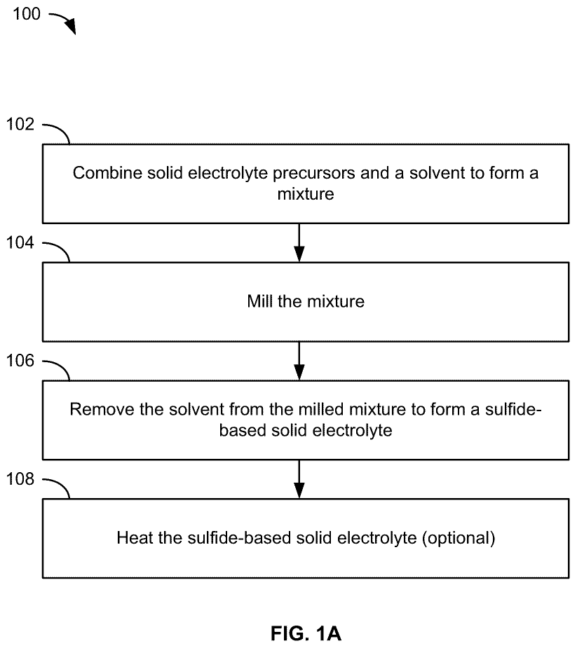

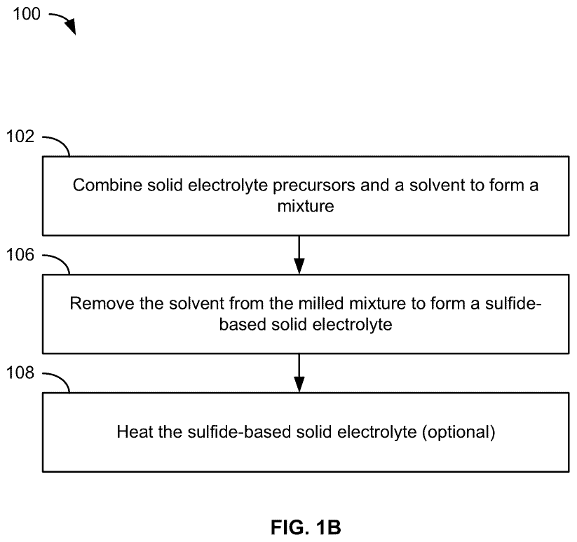

Turning now to FIG. 1A, the process 100 of the present disclosure generally includes: mixing the solid electrolyte precursors and a solvent at step 102 to form a precursor slurry; milling the mixture at step 104; removing the solvent from the mixture at step 106; and, optionally, heating the mixture to form the solid electrolyte material at step 108.

The mixing in step 102 may be accomplished by methods generally known in the art. In some embodiments, agitators including agitated media mills, twin screw compounders, and other high shear equipment may be used to mix the precursors. The duration of mixing is not particularly limited. The mixing in step 102 may be conducted for a period from about 1 minute to about 36 hours, or until the precursor slurry is well-mixed.

In a preferred embodiment, the solid electrolyte precursors may include an alkali metal sulfide, a secondary sulfide, or any combination thereof. The alkali metal sulfide may include lithium sulfide with a surface area of 6 m²/g or greater.

The solvent in the slurry may include but is not limited to an aprotic hydrocarbon, an ester, an ether, a nitrile, an alcohol, or any combination thereof. The aprotic hydrocarbon may include but is not limited to xylenes, toluene, benzene, methyl benzene, hexanes, heptane, octane, alkanes (i.e., a blend of alkanes), isoparaffinic hydrocarbons, decalin 1,2,3,4-tetrahydronaphthalene or any combination thereof. The ester may include but is not limited to butyl butyrate, isobutyl isobutyrate methyl propionate, ethyl propionate, propyl propionate, butyl propionate, methyl acetate, ethyl acetate, propyl acetate, butyl acetate, or any combination thereof. In another aspect, the ether may include but is not limited to diethyl ether, dibutyl ether, benzyl ether, or any combination thereof. In another aspect, the nitrile may include but is not limited to acetonitrile, propionitrile, butyronitrile, pyrrolidine, or any combination thereof. In yet another aspect, the alcohol may include but is not limited to methanol, ethanol, butanol, octanol, or any combination thereof.

In some embodiments, the nitrile solvent may include an alkyl solvent substituted with one or more nitrile groups. The alkyl solvent substituted with one or more nitrile groups may be acyclic. The alkyl solvent substituted with one or more nitrile groups may be linear or branched. The alkyl solvent substituted with one or more nitrile groups may have an alkyl chain length from 1 to 30 carbons, such as from 1 to 20 carbons, from 1 to 15 carbons, 1 to 10 carbons, 1 to 8 carbons, or 1 to 6 carbons. In some embodiments, the alkyl solvent substituted with one or more nitrile groups may have a chain length of 2 or more carbons, 3 or more carbons, 4 or more carbons, 5 or more carbons, 6 or more carbons, 7 or more carbons, 8 or more carbons, and so on. In some examples, the alkyl solvent substituted with one or more nitrile groups may include acetonitrile, propionitrile, butyronitrile, isobutyronitrile, benzonitrile, decanonitrile, pivalonitrile, valeronitrile, or any combination thereof.

In some embodiments, the one or more nitrile solvents may include an aryl solvent substituted with one or more nitrile groups. The aryl solvent substituted with one or more nitrile groups may include three or more carbons, four or more carbons, five or more carbons, six or more carbons, seven or more carbons, eight or more carbons, nine or more carbons, ten or more carbons, and so on. In some embodiments, the aryl solvent substituted with one or more nitrile groups may include from 3 to 12 carbons, such as from 3 to 10 carbons, 3 to 8 carbons, 4 to 6 carbons, or from 5 to 7 carbons. In some examples, the aryl solvent substituted with one or more nitrile groups may include benzonitrile.

In some embodiments, the nitrile solvent may comprise acetonitrile, propionitrile, butyronitrile, isobutyronitrile, benzonitrile, decanonitrile, pivalonitrile, valeronitrile, or other nitrile solvents known in the art and combinations thereof. In specific embodiments, the one or more nitrile solvents may be selected from the group consisting of acetonitrile, propionitrile, butyronitrile, isobutyronitrile, benzonitrile, and combinations thereof.

The amount of solvent present in the precursor slurry may be from about 50% to about 90% by weight of the slurry; in other words, the slurry may have a solids content from about 10% to about 50% by weight of the slurry. In some embodiments, the solvent may be present in the slurry in an amount from about 50% to about 60%, about 50% to about 70%, about 50% to about 80%, about 50% to about 90%, about 60% to about 90%, about 70% to about 90%, or about 80% to about 90% by weight of the slurry.

The milling in step 104 may comprise milling the mixture to a desired particle size. The mixture may be milled for a predetermined period of time at a predetermined temperature to achieve the desired particle size. The milling may be accomplished using an attritor mill, an autogenous mill, a ball mill, a planetary ball mill, a buhrstone mill, a pebble mill, a rod mill, a semi-autogenous grinding mill, a tower mill, a vertical shaft impactor mill, or other milling apparatuses known in the art. Preferably, the milling is accomplished in a planetary ball mill or an attritor mill.

In some embodiments, such as that shown in FIG. 1B, the process 101 may proceed without a milling step. This is most advantageously done when reactive solvents, such as nitrile solvents or alcohols, are used in the slurry.

Mixing time and milling time in steps 102 and 104, respectively, are not specifically limited as long as it allows for appropriate homogenization and reaction of the precursors to generate the solid electrolyte material. The mixing and milling temperatures in steps 102 and 104, respectively, are also not specifically limited as long as it allows for appropriate mixing and is not so high that a precursor enters the gaseous state. The mixing and milling in steps 102 and 104, respectively, may be accomplished in an inert atmosphere, a moisture-free atmosphere, or an ambient atmosphere.

The slurry may have a viscosity from about 10 cP to about 1000 cP at a shear rate of 100 s⁻¹. In some embodiments, the slurry may have a viscosity from about 10 cP to about 50 cP, about 10 cP to about 100 cP, about 10 cP to about 200 cP, about 10 cP to about 300 cP, about 10 cP to about 400 cP, about 10 cP to about 500 cP, about 10 cP to about 600 cP, about 10 cP to about 700 cP, about 10 cP to about 800 cP, about 10 cP to about 900 cP, about 10 cP to about 1000 cP, about 50 cP to about 1000 cP, about 100 cP to about 1000 cP, about 200 cP to about 1000 cP, about 300 cP to about 1000 cP, about 400 cP to about 1000 cP, about 500 cP to about 1000 cP, about 600 cP to about 1000 cP, about 700 cP to about 1000 cP, about 800 cP to about 1000 cP, or about 900 cP to about 1000 cP.

The solvent is removed from the mixture in step 106. The solvent may be removed by various separation methods known in the art, such as evaporation and filtration. In particular embodiments, the solvent may be removed via evaporation, gravity filtration, vacuum filtration, centrifugation, desiccation, spray-drying, and other methods known in the art.

When removing the solvent via evaporation or spray-drying, the milled mixture may be heated to a temperature from about 20° C. to about 250° C. Those having skill in the art will appreciate that the optimal temperature for evaporation will depend on the solvent used; e.g., high-molecular weight hydrocarbons will generally require relatively higher temperatures to evaporate as compared to low-molecular weight hydrocarbons. In some embodiments, the milled mixture may be heated to a temperature from about 20° C. to about 50° C., about 20° C. to about 100° C., about 20° C. to about 150° C., about 20° C. to about 200° C., about 20° C. to about 250° C., about 50° C. to about 250° C., about 100° C. to about 250° C., about 150° C. to about 250° C., or about 200° C. to about 250° C.

The amount of solvent removed may vary. In some embodiments, all or substantially all of the solvent (i.e., 99% or greater) may be removed from the milled mixture. In other embodiments, about 95%, about 90%, about 85%, about 80%, about 75%, or less than about 75% of the solvent may be removed. In still other embodiments, about 99% to about 75% of the solvent may be removed, such as from about 99% to about 95%, about 99% to about 90%, about 99% to about 85%, about 99% to about 80%, about 99% to about 75%, about 95% to about 75%, about 90% to about 75%, about 85% to about 75%, or from about 80% to about 75% of the solvent may be removed.

When process 100 includes the optional heating step 108, the precursors in the milled mixture may be heated to a temperature from about 150° C. to about 600° C. The precursors may be heated to a temperature from about 150° C. to about 200° C., about 150° C. to about 250° C., about 150° C. to about 300° C., about 150° C. to about 350° C., about 150° C. to about 400° C., about 150° C. to about 450° C., about 150° C. to about 500° C., about 150° C. to about 550° C., about 150° C. to about 600° C., about 200° C. to about 600° C., about 250° C. to about 600° C., about 300° C. to about 600° C., about 350° C. to about 600° C., about 400° C. to about 600° C., about 450° C. to about 600° C., about 500° C. to about 600° C., about 550° C. to about 600° C., about 200° C. to about 400° C., about 200° C. to about 350° C., or about 250° C. to about 350° C. As an example, the precursors may be heated in step to a temperature of about 150° C., about 175° C., about 200° C., about 225° C., about 250° C., about 275° C., about 300° C., about 325° C., about 350° C., about 375° C., about 400° C., about 425° C., about 450° C., about 475° C., about 500° C., about 525° C., about 550° C., about 575° C., or about 600° C. Those having skill in the art will appreciate that the temperature may be limited or adjusted based on factors such as the type of equipment used or the atmospheric pressure.

The heating may occur for a period of time from about 5 seconds to about 5 hours. For example, the heating may occur for a period from about 5 second to about 10 seconds, about 5 seconds to about 30 seconds, about 5 seconds to about 1 minute, about 5 seconds to about 10 minutes, about 5 seconds to about 30 minutes, about 5 seconds to about 1 hour, about 5 seconds to about 3 hours, about 5 seconds to about 5 hours, about 10 seconds to about 5 hours, about 30 seconds to about 5 hours, about 1 minute to about 5 hours, about 10 minutes to about 5 hours, about 30 minutes to about 5 hours, about 1 hour to about 5 hours, or about 3 hours to about 5 hours.

The alkali metal halide may include a lithium halide, such as LiF, LiCl, LiBr, LiI, or any combination thereof. The alkali pseudohalide may include a lithium pseudohalide, such as LiNO₃, LiOH, Li₂SO₃, Li₃N, Li₂NH, LiNH₂, LiBF₄, LiBH₄, or any combination thereof.

The alkali metal sulfide may include Li₂S, Na₂S, or LiNaS, or any combination thereof.

The alkaline earth metal sulfide may include MgS, CaS, or any combination thereof.

The secondary halide may include an alkaline earth metal halide. The alkaline earth metal halide may include MgCl₂, MgBr₂, MgI₂, CaCl₂, CaBr₂, CaI₂, or any combination thereof.

The surface area of the alkali metal sulfide may be greater than 6 m²/g. In some aspects the surface area of the alkali metal sulfide material may be greater than 10 m²/g, greater than 20 m²/g, greater than 30 m²/g, greater than 40 m²/g, greater than 50 m²/g, greater than 60 m²/g, greater than 70 m²/g, greater than 80 m²/g, greater than or greater than 90 m²/g.

In some aspects, the surface area of the alkali metal sulfide may be from about 6 m²/g to about 100 m²/g. In some aspects, the surface area of the alkali metal sulfide may be from about 6 m²/g to about 10 m²/g, about 6 m²/g to about 15 m²/g, about 6 m²/g to about 20 m²/g, about 6 m²/g to about 30 m²/g, about 6 m²/g to about 40 m²/g, about 6 m²/g to about 50 m²/g, about 6 m²/g to about 60 m²/g, about 6 m²/g to about 70 m²/g, about 6 m²/g to about 80 m²/g, about 6 m²/g to about 90 m²/g, about 6 m²/g to about 100 m²/g, about 10 m²/g to about 100 m²/g, about 20 m²/g to about 100 m²/g, about 30 m²/g to about 100 m²/g, about 40 m²/g to about 100 m²/g, about 50 m²/g to about 100 m²/g, about 60 m²/g to about 100 m²/g, about 70 m²/g to about 100 m²/g, about 80 m²/g to about 100 m²/g, about 90 m²/g to about 100 m²/g, about 10 m²/g to about 50 m²/g, about 25 m²/g to about 75 m²/g, or about 30 m²/g to about 60 m²/g. As another example, the surface area of the alkali metal sulfide may be about 6 m²/g, 7 m²/g, 8 m²/g, 9 m²/g, 10 m²/g, 11 m²/g, 12 m²/g, 13 m²/g, 14 m²/g, 15 m²/g, 16 m²/g, 17 m²/g, 18 m²/g, 19 m²/g, 20 m²/g, 21 m²/g, 22 m²/g, 23 m²/g, 24 m²/g, 25 m²/g, 26 m²/g, 27 m²/g, 28 m²/g, 29 m²/g, 30 m²/g, 31 m²/g, 32 m²/g, 33 m²/g, 34 m²/g, 35 m²/g, 36 m²/g, 37 m²/g, 38 m²/g, 93 m²/g, 40m²/g, 41m²/g, 42m²/g, 43 m²/g, 44m²/g, 45m²/g, 46m²/g, 47m²/g, 48 m²/g, 49m²/g, 05 m²/g, 51m²/g, 52m²/g, 53 m²/g, 54m²/g, 55m²/g, 56m²/g, 57m²/g, 58 m²/g, 59m²/g, 60m²/g, 16 m²/g, 62m²/g, 63 m²/g, 64m²/g, 65m²/g, 66m²/g, 67m²/g, 68 m²/g, 69m²/g, 70m²/g, 71m²/g, 27 m²/g, 73 m²/g, 74m²/g, 75m²/g, 76m²/g, 77m²/g, 78 m²/g, 79m²/g, 80m²/g, 81m²/g, 82m²/g, 38 m²/g, 84m²/g, 85m²/g, 86m²/g, 87m²/g, 88 m²/g, 89m²/g, 90m²/g, 91m²/g, 92m²/g, 93 m²/g, 49 m²/g, 95 m²/g, 96 m²/g, 97 m²/g, 98 m²/g, 99 m²/g, or about 100 m²/g.

The particle size (D50) of the alkali metal sulfide may be from about 100 nm to about 5 μm. For example, the particle size (D50) of the alkali metal sulfide may be from about 100 nm to about 500 nm, about 100 nm to about 1 μm, about 100 nm to about 2 μm, about 100 nm to about 3 μm, about 100 nm to about 4 μm, about 100 nm to about 5 μm, about 500 nm to about 5 μm, about 1 μm to about 5 μm, about 2 μm to about 5 μm, about 3 μm to about 5 μm, or about 4 μm to about 5 μm. In some aspects, the particle size (D50) of the alkali metal sulfide material may be about 200 nm, about 300 nm, about 400 nm, about 500 nm, about 600 nm, about 700 nm, about 800 nm, about 900 nm, about 1 μm, about 1.5 μm, about 2 μm, about 2.5 μm, about 3 μm, about 3.5 μm, about 4 μm, about 4.5 μm, about 5 μm. The surface area of the alkali metal sulfide may be greater than 6 m²/g. In some aspects the surface area of the alkali metal sulfide material may be greater than 10 m²/g, greater than 20 m²/g, greater than 30 m²/g, greater than 40 m²/g, greater than 50 m²/g, greater than 60 m²/g, greater than 70 m²/g, greater than 80 m²/g, greater than or greater than 90 m²/g.

In some aspects, the surface area of the alkaline earth metal sulfide may be from about 6 m²/g to about 100 m²/g. In some aspects, the surface area of the alkaline earth metal sulfide may be from about 6 m²/g to about 10 m²/g, about 6 m²/g to about 15 m²/g, about 6 m²/g to about 20 m²/g, about 6 m²/g to about 30 m²/g, about 6 m²/g to about 40 m²/g, about 6 m²/g to about 50 m²/g, about 6 m²/g to about 60 m²/g, about 6 m²/g to about 70 m²/g, about 6 m²/g to about 80 m²/g, about 6 m²/g to about 90 m²/g, about 6 m²/g to about 100 m²/g, about 10 m²/g to about 100 m²/g, about 20 m²/g to about 100 m²/g, about 30 m²/g to about 100 m²/g, about 40 m²/g to about 100 m²/g, about 50 m²/g to about 100 m²/g, about 60 m²/g to about 100 m²/g, about 70 m²/g to about 100 m²/g, about 80 m²/g to about 100 m²/g, about 90 m²/g to about 100 m²/g, about 10 m²/g to about 50 m²/g, about 25 m²/g to about 75 m²/g, or about 30 m²/g to about 60 m²/g. As another example, the surface area of the alkaline earth metal sulfide may be about 6 m²/g, 7 m²/g, 8 m²/g, 9 m²/g, 10 m²/g, 11 m²/g, 12 m²/g, 13 m²/g, 14 m²/g, 15 m²/g, 16 m²/g, 17 m²/g, 18 m²/g, 19 m²/g, 20 m²/g, 21 m²/g, 22 m²/g, 23 m²/g, 24 m²/g, 25 m²/g, 26 m²/g, 27 m²/g, 28 m²/g, 29 m²/g, 30 m²/g, 31 m²/g, 32 m²/g, 33 m²/g, 34 m²/g, 35 m²/g, 36 m²/g, 73 m²/g, 38 m²/g, 39 m²/g, 40 m²/g, 41 m²/g, 42 m²/g, 43 m²/g, 44 m²/g, 45 m²/g, 46 m²/g, 47 m²/g, 84 m²/g, 49 m²/g, 50 m²/g, 51 m²/g, 52 m²/g, 53 m²/g, 54 m²/g, 55 m²/g, 56 m²/g, 57 m²/g, 58 m²/g, 95 m²/g, 60 m²/g, 61 m²/g, 62 m²/g, 63 m²/g, 64 m²/g, 65 m²/g, 66 m²/g, 67 m²/g, 68 m²/g, 69 m²/g, 07 m²/g, 71 m²/g, 72 m²/g, 73 m²/g, 74 m²/g, 75 m²/g, 76 m²/g, 77 m²/g, 78 m²/g, 79 m²/g, 80 m²/g, 18 m²/g, 82 m²/g, 83 m²/g, 84 m²/g, 85 m²/g, 86 m²/g, 87 m²/g, 88 m²/g, 89 m²/g, 90 m²/g, 91 m²/g, 29 m²/g, 93 m²/g, 94 m²/g, 95 m²/g, 96 m²/g, 97 m²/g, 98 m²/g, 99 m²/g, or about 100 m²/g.

The particle size (D50) of the alkaline earth metal sulfide may be from about 100 nm to about 5 μm. For example, the particle size (D50) of the alkaline earth metal sulfide may be from about 100 nm to about 500 nm, about 100 nm to about 1 μm, about 100 nm to about 2 μm, about 100 nm to about 3 μm, about 100 nm to about 4 μm, about 100 nm to about 5 μm, about 500 nm to about 5 μm, about 1 μm to about 5 μm, about 2 μm to about 5 μm, about 3 μm to about 5 μm, or about 4 μm to about 5 μm. In some aspects, the particle size (D50) of the alkaline earth metal sulfide material may be about 200 nm, about 300 nm, about 400 nm, about 500 nm, about 600 nm, about 700 nm, about 800 nm, about 900 nm, about 1 μm, about 1.5 μm, about 2 μm, about 2.5 μm, about 3 μm. about 3.5 μm, about 4 μm, about 4.5 μm, about 5 μm.

The secondary sulfide may include, for example, As₂S5, As₂S₃, Sb₂S₅, Sb₂S₃, Al₂S₃, SiS₂, GeS₂, SnS₂, SnS, PbS₂, P₄SX (where x ranges from 3 to 10), P₂S₅, or any combination thereof. In some embodiments, the secondary sulfide may include mixtures of P4Sx, wherein x ranges from 3 to 10. In some embodiments, the secondary sulfide may include a combination of P₄S₃, P₄S₄, P₄S₅, P₄S₆, P₄S₇, P₄S₈, P₄S₉, P₄S₁₀, and P₄Sₓ. In some embodiments, the secondary sulfide may include P₄Sₓ, wherein x>10. In some embodiments, the secondary sulfide may include may include P₄Sₓ, wherein x may be greater than 40, or 10<x≤40. In some aspects, x may be an integer or a non-integer.

In some embodiments when the secondary sulfide includes P₄Sₓ, 10<x≤35, 10<x≤30, 10<x≤25, 10<x≤20, 10<x≤15, 10<x≤14, 10<x≤13, 10<x≤12, or 10<x≤11. In preferred embodiments, 10<x≤14. Without wishing to be bound by theory, when 10<x≤14, the P₄Sₓ is a crystalline-phase material with properties more preferred for forming solid electrolyte materials. When x is greater than about 14, the P₄Sₓ is an amorphous phase material due to the large relative quantities of sulfur.

The secondary sulfide compound may also or alternatively comprise a transition metal sulfide, such as CoS₂, Co₃S₄, CrS, Cr₂S₃, Cr₃S₄, CuS, CuS₂, Cu₂S, FeS, FeS₂, Fe₃S₄, MnS, MnS₂, MoS₂, NiS, NiS₂, Ni₃S₂, ScS, Sc₂S₃, SnS₂, TiS, TiS₂, Ti₂S₃, VS, VS₂, V₂S₃, VS₄, Y₂S₃, ZnS, ZrS₂, WS₂, or other transition metal sulfides known in the art and any combination thereof.

In embodiments wherein the secondary sulfide includes phosphorus, the molar ratio of phosphorus to lithium to sulfur (P:Li:S) may be selected such that the reaction produces a desired solid electrolyte material. The molar amount of phosphorus in the molar ratio may be selected from 1 about to about 4, such as from about 1 to about 2, from about 1 to about 3, from about 2 to about 3, from about 2 to about 4, or from about 3 to about 4. In some examples, the molar amount of phosphorus in the molar ratio may be 1, 1.5, 2, 2.5, 3, 3.5, or 4. The molar amount of lithium in the molar ratio may be selected from about 1 to about 9, such as from about 1 to about 3, from about 1 to about 5, from about 1 to about 7, from about 3 to about 5, from about 3 to about 7, from about 3 to about 9, from about 5 to about 7, from about 5 to about 9, or from about 7 to about 9. In some examples, the molar amount of lithium in the molar ratio may be 1, 1.5, 2, 2.5, 3, 3.5, 4, 4.5, 5, 5.5, 6, 6.5, 7, 7.5, 8, 8.5, or 9. The molar amount of sulfur in the molar ratio may be selected from about 3 to about 12, such as from about 3 to about 6, from about 3 to about 9, from about 3 to about 12, from about 6 to about 9, from about 6 to about 12, or from about 9 to about 12. In some examples, the molar amount of sulfur in the molar ratio may be 3, 3.5, 4, 4.5, 5, 5.5, 6, 6.5, 7, 7.5, 8, 8.5, 9, 9.5, 10, 10.5, 11, 11.5, 12, 12.5, or 13. Thus, the molar ratio of phosphorus to lithium to sulfur may be 1-4: 1-9:3-12, such as 1-2: 5-6: 4-5.

The secondary halide may include BCl₃, BBr₃, Bl₃, AlF₃, AlBr₃, AlI₃, AlCl₃, SiF₄, SiCl₄, SiCl₃, Si₂Cl₆, SiBr₄, SiBrCl₃, SiBr₂Cl₂, SiI₄, PF₃, PF₅, PCl₃, PCl₅, POCl₃, PBr₃, POBr₃, PI₃, P₂Cl₄, P₂I₄, SF₂, SF₄, SF₆, S₂F₁₀, SCl₂, S₂Cl₂, S₂Br₂, GeF₄, GeCl₄, GeBr₄, GeI₄, GeF₂, GeCl₂, GeBr₂, GeI₂, AsF₃, AsCl₃, AsBr₃, AsI₃, AsF₅, SeF₄, SeF₆, SeCl₂, SeCl₄, Se₂Br₂, SeBr₄, SnF₄, SnCl₄, SnBr₄, SnI₄, SnF₂, SnCl₂, SnBr₂, SnI₂, SbF₃, SbCl₃, SbBr₃, SbI₃, SbF₅, SbCl₅, PbF₄, PbCl₄, PbF₂, PbCl₂, PbBr₂, PbI₂, BiF₃, BiCl₃, BiBr₃, BiI₃, TeF₄, Te₂F₁₀, TeF₆, TeCl₂, TeCl₄, TeBr₂, TeBr₄, TeI₄, or any combination thereof.

The solid electrolyte produced by the described processes may be Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In). In some embodiments, the sulfide solid electrolyte material may comprise an argyrodite material having the chemical formula Li_{6-y}PS_{5-y}X_{y}, where X is a halogen or pseudohalogen, and 1≤y≤2.

In another embodiment, the solid electrolyte material produced by the described processes may include Li₃PS₄, Li₄P₂S₆, Li₇P₃S₁₁, Li₁₀GeP₂S₁₂, Li₁₀SnP₂S₁₂, or any combination thereof. In a further embodiment, the solid electrolyte material may include Li₆PS₅Cl, Li₆PS₅Br, Li₆PS₅I, or Li_{7-y}PS_{6-y}X_{y}, wherein “X” represents a halogen or a pseudo-halogen; 0<y≤2.0; wherein the halogen may include F, Cl, Br, I, or any combination thereof; and the pseudo-halogen may include N, NH, NH₂, NO, NO₂, BF₄, BH₄, AlH₄, CN, SCN, or any combination thereof. In yet another embodiment, the solid electrolyte material include Li_{8-y-z}P₂S_{9-y-z}X_{y}W_{z}, wherein “X” and “W” each independently represent a halogen or a pseudo-halogen; 0≤y≤1; 0≤z≤1; the halogen may include F, Cl, Br, I, or any combination thereof; and the pseudo-halogen may include N, NH, NH₂, NO, NO₂, BF₄, BH₄, AlH₄, CN, SCN, or any combination thereof.

A further iteration of the current invention, provided herein, is a process for producing a sulfide-based solid electrolyte including milling a precursor slurry wherein the slurry includes an alkali metal sulfide composite including two or more alkali metal sulfides having a multimodal particle size distribution, a secondary sulfide, and at least one solvent to form an intermediate. The alkali metal sulfide composite may optionally include an alkali halide, an alkali pseudohalide, a secondary halide, or a combination thereof. The alkali metal sulfide composite may further have a specific surface area greater than 6 m²/g. In some embodiments, the process further comprises heating the intermediate to form the desired sulfide-based solid electrolyte.

The intermediate may include amorphous materials and unreacted precursors. The intermediate may be further heat treated to form a sulfide-based solid electrolyte. In an embodiment, the intermediate may include Li₃PS₄, which may be heat treated to form an Argyrodite sulfide-based solid electrolyte. In another embodiment, the intermediate may include Li₁₅P₄S₁₆Cl_{3.}

In some aspects, the intermediate and/or sulfide-based solid electrolyte may be heated to a temperature from about 150° C. to about 600° C. For example, the intermediate and/or sulfide-based solid electrolyte may be heated to a temperature from about 150° C. to about 300° C., about 150° C. to about 450° C., about 150° C. to about 600° C., about 300° C. to about 450° C., about 300° C. to about 600° C., or about 450° C. to about 600° C. In still further embodiments, the process further comprises drying the sulfide-based solid electrolyte under vacuum or atmospheric pressure.

The two or more alkali metal sulfides, the secondary sulfide, the solvent, the alkali halide, the alkali pseudohalide, and the secondary halide may be any of those described above.

A multimodal particle size distribution may be defined as a particle size distribution having greater than one mode (i. e monomodal). Examples of multimodal particle size distribution may be bimodal, trimodal, quadmodal, etc.

For example, when the alkali metal sulfide composite contains two alkali metal sulfides (i.e., a first alkali metal sulfide and a second alkali metal sulfide), wherein each alkali metal sulfide has a different particle size, the alkali metal sulfide composite can be understood to have a bimodal particle size distribution. The first alkali metal sulfide and the second alkali metal sulfide may each be the same species of alkali metal sulfide. When the alkali metal sulfide composite contains three alkali metal sulfides (i.e., a first alkali metal sulfide, a second alkali metal sulfide, and a third alkali metal sulfide), wherein each alkali metal sulfide has a different particle size, the alkali metal sulfide composite can be understood to have a trimodal particle size distribution. Furthermore, when the alkali metal sulfide composite contains four alkali metal sulfides (i.e., a first alkali metal sulfide, a second alkali metal sulfide, a third alkali metal sulfide, and a fourth alkali metal sulfide), wherein each alkali metal sulfide material has a different particle size, the alkali metal sulfide composite should be understood to have a quadmodal particle size distribution.

The alkali metal sulfide composite may comprise a first alkali metal sulfide and a second alkali metal sulfide. The ratio between the particle size (D50) of the first alkali metal sulfide and the particle size (D50) of the second alkali metal sulfide may range from 1:2 to 1:50. In some embodiments, the ratio of the particle size (D50) of the first alkali metal sulfide to the particle size (D50) of the second alkali metal sulfide may range from 1:2 to 1:50, or from 1:5 to 1:50, or from 1:5 to 1:40, or from 1:5 to 1:30, or from 1:5 to 1:20, or from 1:5 to 1:15, or from 1:5 to 1:10.

The particle size (D50) of the first alkali metal sulfide may be about 100 nm. For example, the particle size (D50) of the first alkali metal sulfide may be from about 100 nm to about 500 nm, about 100 nm to about 1 μm, about 100 nm to about 5 μm, about 500 nm to about 5 μm, or about 1 μm to about 5 μm. In some aspects, the particle size (D50) of the first alkali metal sulfide may be about 200 nm, about 300 nm, about 400 nm, about 500 nm, about 600 nm, about 700 nm, about 800 nm, about 900 nm, about 1 μm, about 1.5 μm, about 2 μm, about 2 μm, about 3 μm, about 4 μm, or about 5 μm.

The particle size (D50) of the second alkali metal sulfide may be about 200 nm. For example, the particle size (D50) of the second alkali metal sulfide may be from about 200 nm to about 500 nm, about 200 nm to about 1 μm, about 200 nm to about 5 μm, about 200 nm to about 10 μm, about 200 nm to about 30 μm, about 500 nm to about 30 μm, about 1 μm to about 30 μm, about 5 μm to about 30 μm, or about 10 μm to about 30 μm. In some aspects, the particle size (D50) of the alkali metal sulfide may about 300 nm, about 400 nm, about 500 nm, about 600 nm, about 700 nm, about 800 nm, about 900 nm, about 1 μm, about 1.5 μm, about 2 μm, about 2 μm, about 3 μm, about 4 μm, about 5 μm, about 6 μm, about 7 μm, about 8 μm, about 9 μm, about 10 μm. about 15 μm, about 20 μm, or about 30 μm.

In some aspects, the surface area of the first alkali metal sulfide may be from about 6 m²/g to about 100 m²/g. In some aspects, the surface area of the first alkali metal sulfide may be from about 6 m²/g to about 10 m²/g, about 6 m²/g to about 15 m²/g, about 6 m²/g to about 20 m²/g, about 6 m²/g to about 30 m²/g, about 6 m²/g to about 40 m²/g, about 6 m²/g to about 50 m²/g, about 6 m²/g to about 60 m²/g, about 6 m²/g to about 70 m²/g, about 6 m²/g to about 80 m²/g, about 6 m²/g to about 90 m²/g, about 6 m²/g to about 100 m²/g, about 10 m²/g to about 100 m²/g, about 20 m²/g to about 100 m²/g, about 30 m²/g to about 100 m²/g, about 40 m²/g to about 100 m²/g, about 50 m²/g to about 100 m²/g, about 60 m²/g to about 100 m²/g, about 70 m²/g to about 100 m²/g, about 80 m²/g to about 100 m²/g, about 90 m²/g to about 100 m²/g, about 10 m²/g to about 50 m²/g, about 25 m²/g to about 75 m²/g, or about 30 m²/g to about 60 m²/g. As another example, the surface area of the first alkali metal sulfide may be about 6 m²/g, 7 m²/g, 8 m²/g, 9 m²/g, 10 m²/g, 11 m²/g, 12 m²/g, 13 m²/g, 14 m²/g, 15 m²/g, 16 m²/g, 17 m²/g, 18 m²/g, 19 m²/g, 20 m²/g, 21 m²/g, 22 m²/g, 23 m²/g, 24 m²/g, 25 m²/g, 26 m²/g, 27 m²/g, 28 m²/g, 29 m²/g, 30 m²/g, 31 m²/g, 32 m²/g, 33 m²/g, 34 m²/g, 35 m²/g, 36 m²/g, 37 m²/g, 38 m²/g, 39 m²/g, 40 m²/g, 41 m²/g, 42 m²/g, 43 m²/g, 44 m²/g, 45 m²/g, 46 m²/g, 47 m²/g, 48 m²/g, 4 m²/g, 50 m²/g, 51 m²/g, 52 m²/g, 53 m²/g, 54 m²/g, 55 m²/g, 56 m²/g, 57 m²/g, 58 m²/g, 59 m²/g, 6 m²/g, 61 m²/g, 62 m²/g, 63 m²/g, 64 m²/g, 65 m²/g, 66 m²/g, 67 m²/g, 68 m²/g, 69 m²/g, 70 m²/g, 7 m²/g, 72 m²/g, 73 m²/g, 74 m²/g, 75 m²/g, 76 m²/g, 77 m²/g, 78 m²/g, 79 m²/g, 80 m²/g, 81 m²/g, 8 m²/g, 83 m²/g, 84 m²/g, 85 m²/g, 86 m²/g, 87 m²/g, 88 m²/g, 89 m²/g, 90 m²/g, 91 m²/g, 9 m²/g, 39 m²/g, 94 m²/g, 95 m²/g, 96 m²/g, 97 m²/g, 98 m²/g, 99 m²/g, or about 100 m²/g.

The surface area of the first alkali metal sulfide may be greater than 6 m²/g. In some aspects the surface area of the first alkali metal sulfide may be greater than 10 m²/g, greater than 20 m²/g, greater than 30 m²/g, greater than 40 m²/g, greater than 50 m²/g, greater than 60 m²/g, greater than 70 m²/g, greater than 80 m²/g, or greater than 90 m²/g.

The surface area of the second alkali metal sulfide may be larger than the surface area of the first alkali metal sulfide. The surface area of the second alkali metal sulfide may be less than 50 m²/g. In some aspects the surface area of the second alkali metal sulfide may be less than 45 m²/g, less than 40 m²/g, less than 35 m²/g, less than 30 m²/g, less than 25 m²/g, less than 20 m²/g, less than 15 m²/g, or less than 10 m²/g.

In some aspects, the surface area of the second alkali metal sulfide may be from about 4 m²/g to about 50 m²/g. In some aspects the surface area of the second alkali metal sulfide may be from about 4 m²/g to about 10 m²/g, about 4 m²/g to about 20 m²/g, about 4 m²/g to about 30 m²/g, about 4 m²/g to about 40 m²/g, about 4 m²/g to about 50 m²/g, about 10 m²/g to about 50 m²/g, about 20 m²/g to about 50 m²/g, about 30 m²/g to about 50 m²/g, about 40 m²/g to about 50 m²/g, about 10 m²/g to about 30 m²/g, or about 10 m²/g to about 20 m²/g. As another example, the surface area of the second alkali metal sulfide may be about 4 m²/g, 5 m²/g, 6 m²/g, 7 m²/g, 8 m²/g, 9 m²/g, 10 m²/g, 11 m²/g, 12 m²/g, 13 m²/g, 14 m²/g, 15 m²/g, 16 m²/g, 17 m 2/g, 18 m²/g, 19 m²/g, 20 m²/g, 21 m²/g, 22 m²/g, 23 m²/g, 24 m²/g, 25 m²/g, 26 m²/g, 27 m²/g, 28 m²/g, 29 m²/g, 30 m²/g, 31 m²/g, 32 m²/g, 33 m²/g, 34 m²/g, 35 m²/g, 36 m²/g, 37 m²/g, 38 m²/g, 39 m²/g, 40 m²/g, 41 m²/g, 42 m²/g, 43 m²/g, 44 m²/g, 45 m²/g, 46 m²/g, 47 m²/g, 48 m²/g, 94 m²/g, or about 50 m²/g.

In some embodiments, the alkali metal sulfide composite may further contain a third alkali metal sulfide, wherein the third alkali metal sulfide has a different particle size (D50) when compared to the first and second alkali metal sulfides. The first alkali metal sulfide, the second alkali metal sulfide, and the third alkali metal sulfide may each be the same species of alkali metal sulfide. The particle size (D50) of the third alkali metal sulfide may be about 300 nm. For example, the particle size (D50) of the third alkali metal sulfide may be from about 300 nm to about 500 nm, about 300 nm to about 1 μm, about 300 nm to about 10 μm, about 300 nm to about 50 μm, about 300 nm to about 100 μm, about 500 nm to about 100 μm, about 1 μm to about 100 μm, about 10 μm to about 100 μm, or about 50 μm to about 100 μm. In some aspects, the particle size (D50) of the third alkali metal sulfide may be about 300 nm, about 400 nm, about 500 nm, about 600 nm, about 700 nm, about 800 nm, about 900 nm, about 1 μm, about 1.5 μm, about 2 μm, about 2 μm, about 3 μm, about 4 μm, about 5 μm, about 6 μm, about 7 μm, about 8 μm, about 9 μm, about 10 μm, about 15 μm, about 20 μm, about 30 μm, about 40 μm, about 50 μm, about 60 μm, about 70 μm, about 80 μm, about 90 μm, or about 100 μm.

When the alkali metal sulfide composite comprises a first alkali metal sulfide, a second alkali metal sulfide, and a third alkali metal sulfide, the ratio of the particle size (D50) of the first alkali metal sulfide to the particle size (D50) of the third alkali metal sulfide may range from 1:2 to 1:1000. In some embodiments, the ratio of the particle size (D50) of the first alkali metal sulfide to the particle size (D50) of the third alkali metal sulfide may range from 1:3 to 1:1000, or from 1:5 to 1:1000, or from 1:10 to 1:1000, or from 1:20 to 1:1000, or from 1:50 to 1:1000, or from 1:100 to 1:1000, or from 1:500 to 1:1000. In some embodiments, the third alkali metal sulfide may have a particle size that is at least two times greater than the D50 particle size of the second alkali metal sulfide.

The surface area of the third alkali metal sulfide may be less than 20 m²/g. In some aspects the surface area of the alkali metal sulfide material may be less than 19 m²/g, less than 18 m²/g, less than 17 m²/g, less than 16 m²/g, less than 15 m²/g, less than 14 m²/g, less than 13 m²/g, less than 12 m²/g, less than 11 m²/g, less than 10 m²/g, less than 9 m²/g, less than 8 m²/g, less than 7 m²/g, or less than 6 m²/g. In some embodiments, the surface area of the third alkali metal sulfide may be from about 1 m2/g to about 20 m2/g, such as from about 1 m²/g to about 5 m²/g, about 1 m²/g to about 10 m²/g, about 1 m²/g to about 15 m²/g, about 1 m²/g to about 20 m²/g, about 5 m²/g to about 10 m²/g, about 5 m²/g to about 15 m²/g, about 5 m²/g to about 20 m²/g, about 10 m²/g to about 15 m²/g, about 10 m²/g to about 20 m²/g, or about 15 m²/g to about 20 m²/g. As another example, the surface area of the third alkali metal sulfide may be about 1 m²/g, 2 m²/g, 3 m²/g, 4 m²/g, 5 m²/g, 6 m²/g, 7 m²/g, 8 m²/g, 9 m²/g, 10 m²/g, 11 m²/g, 12 m²/g, 13 m²/g, 14 m²/g, 15 m²/g, 16 m²/g, 17 m²/g, 18 m²/g, 19 m²/g, or about 20 m²/g.

### Enumerated Embodiments

Embodiment 1: A process for producing a sulfide-based solid electrolyte comprising:
preparing a slurry by mixing a solvent and electrolyte precursors, the electrolyte precursors comprising:
   an alkali metal sulfide having a surface area greater than 6 m²/g or an alkaline earth metal sulfide having a surface area greater than 6 m²/g, and
   a secondary sulfide; and
drying the slurry to produce a sulfide-based solid electrolyte.

Embodiment 2: The process of embodiment 1, wherein the electrolyte precursors further comprise LiX, wherein X is F, Cl, Br, or I.

Embodiment 3: The process of embodiment 1 or 2, wherein the alkali metal sulfide comprises A₂S, wherein A is Li, Na, or any combination thereof.

Embodiment 4: The process of any one of embodiments 1-3, wherein the secondary sulfide comprises P₂S5, SiS2, Sb₂S3, GeS2, SnS2, or any combination thereof.

Embodiment 5: The process of any one of embodiments 1-4, wherein the alkali metal sulfide has a D50 particle size of 100 nm or larger.

Embodiment 6: The process of any one of embodiments 1-5, wherein the sulfide-based solid electrolyte comprises an Argyrodite phase and the alkali metal sulfide comprises Li₂S.

Embodiment 7: The process of any one of embodiments 1-6, wherein the solvent comprises an ether, ester, nitrile, or hydrocarbon solvent.

Embodiment 8: The process of any one of embodiments 1-7, wherein the solvent comprises acetonitrile, propionitrile, butyronitrile, isobutyronitrile, benzonitrile, or any combination thereof.

Embodiment 9: The process of any one of embodiments 1-8, wherein the solvent comprises an alkane, a blend of alkanes, xylene, toluene, benzene, decalin, 1,2,3,4-tetrahydronaphthalene, or any combination thereof.

Embodiment 10: The process of any one of embodiments 1-9, wherein the drying comprises spray-drying at a temperature from about 20° C. to about 250° C.

Embodiment 11: The process of any one of embodiments 1-10, further comprising heating the sulfide-based solid electrolyte to a temperature from about 150° C. to about 600°C.

Embodiment 12: A process for producing a sulfide-based solid electrolyte comprising:
preparing a slurry by mixing a solvent and electrolyte precursors, the electrolyte precursors comprising:
   An alkali metal sulfide composite, and
   a secondary sulfide; and
drying the slurry to produce the sulfide-based solid electrolyte, wherein the alkali metal sulfide composite comprises a first alkali metal sulfide and a second alkali metal sulfide, wherein the second alkali metal sulfide has a D50 particle size that is at least two times greater than the D50 particle size of the first alkali metal sulfide.

Embodiment 13: The process of embodiment 12, wherein the first alkali metal sulfide comprises lithium.

Embodiment 14: The process of embodiment 12 or 13, wherein the second alkali metal sulfide comprises lithium.

Embodiment 15: The process of any one of embodiments 12-14, wherein the second alkali metal sulfide has a D50 particle size that is at least 10 times greater than the D50 particle size of the first alkali metal sulfide.

Embodiment 16: The process of any one of embodiments 12-15, wherein the electrolyte precursors further comprise LiX, wherein X is F, Cl, Br, or I.

Embodiment 17: The process of any one of embodiments 12-16, wherein the electrolyte precursors further comprise LiX, wherein X is F, Cl, Br, or I.

Embodiment 18: The process of any one of embodiments 12-17, wherein the alkali metal sulfide comprises A₂S where A is one or more of Li and Na.

Embodiment 19: The process of any one of embodiments 12-18, wherein the secondary sulfide comprises one or more of P₂S5, SiS2, Sb₂S3, GeS2, SnS2.

Embodiment 20: The process of any one of embodiments 12-19, wherein the first alkali metal sulfide has a D50 particle size of 100 nm or larger.

Embodiment 21: The process of any one of embodiments 12-20, wherein the sulfide-based solid electrolyte comprises an Argyrodite phase, and the alkali metal sulfide comprises Li₂S.

Embodiment 22: The process of any one of embodiments 12-21, wherein the solvent comprises an ether, ester, nitrile, or hydrocarbon.

Embodiment 23: The process of any one of embodiments 12-22, wherein the solvent comprises acetonitrile, propionitrile, butyronitrile, isobutyronitrile, benzonitrile, and combinations thereof.

Embodiment 24: The process of any one of embodiments 12-23, wherein the solvent comprises an alkane or blend of alkanes, xylene, toluene, benzene, decalin, 1,2,3,4-tetrahydronaphthalene, or any combination thereof.

Embodiment 25: The process of any one of embodiments 12-24, wherein the drying comprises spray-drying at a temperature ranging from about 20° C. to about 250° C.

Embodiment 26: The process of any one of embodiments 12-25, further comprising heating the sulfide-based solid electrolyte to a temperature from about 150° C. to about 600° C.

### EXAMPLES

### Example 1

Li₂S, P₂S₅, and LiCl were added to a horizontal milling unit along with a ceramic grinding agent. These materials were in such a ratio as to produce a solid electrolyte having a composition of the following formula: Li₆₋ₓPS₅₋ₓClₓ where 1≤x≤1.8. To this mill, a hydrocarbon-based solvent such as xylenes and an ester solvent were added, forming a slurry. The mixture had a solids content of about 14 wt % solids. The surface area of the Li₂S material used during the milling process was about 11 m²/g and the D 50 particle size was about 4.5 μm. The materials were milled together for a period of time greater than 1 hour. The viscosity of the slurry during the milling process was about 15 cP at a shear rate of 100 s⁻¹ . After milling, the solvent was removed by heating under vacuum conditions to create an intermediate. This intermediate was then subject to a heat treatment of greater than 300° C. for a period of time longer than 1 hour. The resulting material was a solid electrolyte having a composition of the following formula: Li₆₋ₓPS₅₋ₓClₓ where 1≤x≤1.8.

### Example 2

Example 2 was conducted in the same manner as Example 1 except the solids loading was increased to about 17 wt% solids. The viscosity of the slurry during the milling process was about 150 cP at a shear rate of 100 s⁻¹.

### Example 3

Example 3 was conducted in the same manner as Example 1 except the Li₂S material used had a surface area of about 6 m²/g and the D 50 particle size was about 5.3 μm. The viscosity of the slurry during the milling process was about 300 cP at a shear rate of 100 s⁻¹.

### Example 4

Example 4 was conducted in the same manner as Example 2 except the Li₂S material used had a surface area of about 6 m²/g and the D50 particle size was about 5.3 μm. The viscosity of the slurry during the milling process was about 625 cP at a shear rate of 100 s⁻¹.

What is claimed:

1. A process for producing a sulfide-based solid electrolyte comprising:
preparing a slurry by mixing a solvent and electrolyte precursors, the electrolyte precursors comprising:
an alkali metal sulfide having a surface area greater than 6 m²/g or an alkaline earth metal sulfide having a surface area greater than 6 m²/g, and
a secondary sulfide; and
drying the slurry to produce a sulfide-based solid electrolyte.

2. The process of claim 1, wherein the electrolyte precursors further comprise LiX, wherein X is F, Cl, Br, or I.

3. The process of claim 1, wherein the alkali metal sulfide comprises A₂S, wherein A is Li, Na, or any combination thereof.

4. The process of claim 1, wherein the secondary sulfide comprises P₂S₅, SiS₂, Sb₂S₃, GeS₂, SnS₂, or any combination thereof.

5. The process of claim 1, wherein the alkali metal sulfide has a D50 particle size of 100 nm or larger.

6. The process of claim 1, wherein the sulfide-based solid electrolyte comprises an Argyrodite phase and the alkali metal sulfide comprises Li₂S.

7. The process of claim 1, wherein the solvent comprises an ether, ester, nitrile, or hydrocarbon solvent.

8. The process of claim 1, wherein the solvent comprises acetonitrile, propionitrile, butyronitrile, isobutyronitrile, benzonitrile, or any combination thereof.

9. The process of claim 1, wherein the solvent comprises an alkane, a blend of alkanes, xylene, toluene, benzene, decalin, 1,2,3,4-tetrahydronaphthalene, or any combination thereof.

10. The process of claim 1, wherein the drying comprises spray-drying at a temperature from about 20° C. to about 250° C.

11. The process of claim 1, further comprising heating the sulfide-based solid electrolyte to a temperature from about 150° C. to about 600° C.

12. A process for producing a sulfide-based solid electrolyte comprising:
preparing a slurry by mixing a solvent and electrolyte precursors, the electrolyte precursors comprising:
an alkali metal sulfide composite, and
a secondary sulfide; and
drying the slurry to produce the sulfide-based solid electrolyte, wherein the alkali metal sulfide composite comprises a first alkali metal sulfide and a second alkali metal sulfide, wherein the second alkali metal sulfide has a D50 particle size that is at least two times greater than the D50 particle size of the first alkali metal sulfide.

13. The process of claim 12, wherein the first alkali metal sulfide comprises lithium.

14. The process of claim 12, wherein the second alkali metal sulfide comprises lithium.

15. The process of claim 12, wherein the second alkali metal sulfide has a D50 particle size that is at least 10 times greater than the D50 particle size of the first alkali metal sulfide.

16. The process of claim 12, wherein the alkali metal sulfide composite further comprises a third alkali metal sulfide having a D50 particle size that is at least two times greater than the D50 particle size of the second alkali metal sulfide.

17. The process of claim 12, wherein the electrolyte precursors further comprise LiX, wherein X is F, Cl, Br, or I.

18. The process of claim 12, wherein the alkali metal sulfide comprises A₂S where A is one or more of Li and Na.

19. The process of claim 12, wherein the secondary sulfide comprises one or more of P₂S SiS₂, Sb₂S₃, GeS₂, SnS_{2.}

20. The process of claim 12, wherein the first alkali metal sulfide has a D50 particle size of 100 nm or larger.

21. The process of claim 12, wherein the sulfide-based solid electrolyte comprises an Argyrodite phase, and the alkali metal sulfide comprises Li₂S.

22. The process of claim 12, wherein the solvent comprises an ether, ester, nitrile, or hydrocarbon.

23. The process of claim 12, wherein the solvent comprises acetonitrile, propionitrile, butyronitrile, isobutyronitrile, benzonitrile, and combinations thereof.

24. The process of claim 12, wherein the solvent comprises an alkane or blend of alkanes, xylene, toluene, benzene, decalin, 1,2,3,4-tetrahydronaphthalene, or any combination thereof.

25. The process of claim 12, wherein the drying comprises spray-drying at a temperature ranging from about 20° C. to about 250° C.

26. The process of claim 12, further comprising heating the sulfide-based solid electrolyte to a temperature from about 150° C. to about 600° C.
